(19) United States
(12) Patent Application Publication
(10) Pub. No.: US 2026/0260207 A1
(43) Pub. Date: Sep. 3, 2026

(54) USING A MACHINE-LEARNING MODEL TO DYNAMICALLY SELECT CHARACTERISTICS OF A BATCH FOR PRESENTATION IN AN INTERFACE

(71) Applicant: Maplebear Inc., San Francisco, CA (US)

(72) Inventor: Naval Shah, Toronto (CA)

(21) Appl. No.: 19/067,416

(22) Filed: Feb. 28, 2025

(51) Int. Cl. G06Q 10/087

(52) U.S. Cl. CPC G06Q 10/087

(57) ABSTRACT

An online system receives orders from users and fulfills the orders by presenting batches to pickers, who select one or more batches to fulfill. A picker views an interface generated for a batch via a picker client device to review attributes of the batch when determining whether to select the batch. However, a picker client device often has a limited display area for the interface, and different attributes of a batch have varying amounts of relevance to different pickers when determining whether to select the batch. To tailor an interface for a batch to a specific picker, the online system uses a trained batch outcome prediction model to determine probabilities of different attributes of a batch causing an attrition event for the picker selecting the batch when presented. The online system selects one or more attributes of the batch to present in the interface based on the probabilities.

### BACKGROUND

Various online systems offer items for acquisition by users, with a user selecting one or more items through interaction with the online system. For example, a user includes one or more items in an order by selecting items via one or more interfaces generated and presented by the online system. Subsequently, the user receives the selected items included in the order from the online system. For example, the online system allocates an order from a user to a picker who obtains items included in the order from a source and delivers the obtained items to a location included in the order.

Many online systems generate batches that each include one or more orders. Grouping orders into a batch allows an online system to combine orders to expedite fulfillment of the orders. Attributes of a batch are presented to pickers, who determine whether to select the batch for fulfillment based on the presented attributes. Online systems generate an interface for a batch including attributes of the batch that is presented to a picker, who determines whether to select the batch based on the attributes presented by the interface. Conventional online systems include a common group of attributes in interfaces generated for different batches, presenting the group of attributes for each batch to multiple pickers.

However, different pickers often determine whether to select a batch based on different attributes of the batch. For example, certain pickers prioritize a total weight of items included in a batch when determining whether to select the batch, while other pickers determine whether to select a batch based on a total number of items included in the batch. Generating interfaces for batches that include a common group of attributes for each batch does not account for variations in picker-specific emphasis on different attributes of batches when determining whether to select a batch.

Further, many pickers use portable client devices, such as mobile devices, with limited display area and limited power supplies to review interfaces generated for batches to determine whether to select the batches. With a limited display area for presenting an interface including attributes of a batch, failing to account for picker-specific preferences for attributes of the batch in the interface inefficiently uses the limited display area, increasing a length of time a picker views the interface via a client device. Such an increased length of time for viewing the interface extends an amount of time the client device displays the interface (or other content about a batch), increasing power consumption by the client device while the picker determines whether to select a batch, which decreases an amount of time a portable power supply, such as a battery, allows the picker to continue using the client device.

### SUMMARY

In accordance with one or more aspects of the disclosure, an online system, such as an online concierge system, receives orders from various users. An order identifies one or more items as well as a source for obtaining items in the order. The order may include information about fulfilling the order, such as a time interval for the user to receive items from the order and a location to which items from the order are to be provided after being obtained from the identified source.

The online system identifies one or more batches of orders to pickers, who determine whether to select a batch based on attributes of the batch. A batch includes one or more orders, and the online system may determine orders to include in a batch based on attributes of the orders. For example, a batch includes multiple orders identifying a common source or includes multiple orders that identify different sources within a threshold distance of each other. However, a batch may include a single order. When a picker selects a batch via the online system, the picker subsequently obtains items from one or more sources identified by orders in the selected batch and delivers the items to locations identified by the orders in the selected batch.

When identifying a batch to a picker, the online system generates an interface presenting at least a group of attributes of the batch to the picker. The group comprises a subset of attributes of the batch in various embodiments, which reduces a number of attributes of the batch presented to the picker. Based on the attributes of the batch presented by the interface, the picker determines whether to select the batch. The online system generates and presents an interface for different batches, such as an interface for each batch associated with a geographic location including the picker that is not allocated to a picker. While the subset of attributes of a batch presented by an interface allows a picker to evaluate a batch for selection, different attributes of a batch differently influence different pickers whether to select the batch. For example, a total weight of items included in a batch may determine whether a specific picker selects the batch, while another picker determines whether to select the batch based on a number of items in the batch obtained by the picker performing specific interactions in a source rather than the total weight of items in the batch. Conventional online systems include a common group of attributes of a batch, comprising a subset of attributes of the batch, in interfaces generated for different pickers, which prevents conventionally generated interfaces presented to different pickers from accounting for picker-specific emphasis on different attributes when identifying attributes of a batch to different pickers.

To more efficiently present attributes of a batch to a picker via a display area of a picker client device, the online system obtains a batch for evaluation by a picker. The batch is eligible to be selected by the picker evaluating the batch. For example, the batch may be eligible to be selected by the picker because it includes sources that are in a geographic location including the picker, or because the batch was received by the online system during a time period when the picker had accessed the online system and became eligible to work.

The online system retrieves attributes of the batch, which may include batch item attributes of items included in the batch. Example batch item attributes include: a number of unique items in the batch, a total number of units of items included in the batch, a total weight of items included in the batch, a total volume of items included in the batch, a number of items in the batch obtained through specific interactions within a source identified by the batch (e.g., obtained from an individual within the source, obtained through providing specific information to the source), a number of items in the batch that are fragile, or other attributes describing items included in the batch. Other attributes of the batch may be acquisition attributes that describe acquisition of items by the picker. Example acquisition attributes include: an estimated amount of time for the picker to fulfill the batch, features of one or more locations for delivering items in the batch (e.g., an indication whether a location is an apartment, whether a location includes stairs or an elevator), an amount of user interaction when delivering items in the batch (e.g., an indication whether the picker interacts with the user from whom an order in the batch was received when delivering items to a location in the order), a total amount of compensation to the picker for fulfilling the batch, an amount the picker receives from one or more users having orders included in the batch for fulfilling the batch, an amount the picker receives from the online system for fulfilling the batch, or other information describing acquisition of items in the batch by the picker. However, the batch may have different or additional attributes in various embodiments.

The online system retrieves the attributes of the batch from stored information describing the batch. Additionally, the online system identifies a set of attributes of the batch. For example, the set of attributes of the batch includes a specific number of attributes of the batch. In different embodiments, the set may include different numbers of attributes of the batch. Alternatively, the set of attributes of the batch includes all attributes of the batch. The set of attributes may be predetermined by the online system in some embodiments; alternatively, the online system identifies the set of attributes based on prior selection of orders by pickers or based on other information. Specific attributes of the batch are included in the set in various embodiments.

The online system also retrieves characteristics of the picker to whom information about the batch is to be presented based on information maintained by the online system. A characteristic of the picker includes a history of prior batches presented to the picker. In various embodiments, the history of prior batches includes an entry for each prior batch presented to the picker. In some embodiments, the history of prior batches includes an entry for each prior batch presented to the picker during a specific time interval. The entry for a prior batch includes an indication whether the picker selected or did not select the prior batch. In some embodiments, the history of prior batches presented to the picker includes an amount of time from a prior batch being presented to the picker to the picker selecting (or rejecting) the prior batch. Another example characteristic of the picker is an average amount of time between the picker being presented with a batch and the picker selecting (or rejecting) the batch in some embodiments. The online system may prompt the picker to identify one or more attributes of a prior batch that caused the picker to reject the prior batch and include the one or more identified attributes in the history of prior batches in association with the prior batch.

In various embodiments, the characteristics of the picker include a cancellation history of the picker including previous batches that the picker selected for fulfillment and cancelled after selection. For example, the cancellation history includes attributes of a previous batch that the picker cancelled after selecting, such as batch item attributes or acquisition attributes, as further described above. Different or additional attributes of or information about a previous batch that the picker cancelled after selection may be included in the cancellation history in various embodiments. Characteristics of the picker may include one or more reasons for the picker cancelling a previous batch or not selecting a prior batch. In some embodiments, the online system determines a reason for the picker cancelling a previous batch after selection based on a chat history for the previous batch including messages between the picker and a user from whom the previous batch was received. The online system identifies one or more attributes of the previous batch having at least a threshold probability of causing the picker to cancel fulfillment of the previous batch from the chat history for the previous batch in various embodiments. The online system includes the one or more identified attributes of the previous batch in the cancellation history in association with the previous batch to identify one or more attributes of the previous batches causing cancellation of fulfillment of the previous batch by the picker.

The online system applies a batch outcome prediction model to the characteristics of the picker, the attributes of the batch, and an attribute of the set. The batch outcome prediction model is trained to generate a probability of displaying an attribute of the set of attributes of the batch to the picker resulting in an attrition event resulting from the picker selecting the batch. In various embodiments, an attrition event from the picker selecting the batch comprises the picker cancelling fulfillment of the batch after selecting the batch. An attrition event may also—or alternatively—comprise the picker providing negative feedback about the picker's experience in completing the order, picker churn in which the picker works or otherwise engages less after the attrition event, or any other outcome that causes a bad experience for the picker. Multiple attrition events comprise an attrition event in some embodiments, allowing the batch output prediction model to account for different types of potential attrition events.

In various embodiments, the online system trains the batch outcome prediction model based on a training dataset including multiple training examples. Each training example includes a training attribute, a set of training attributes for a training batch, and training characteristics of a training picker. In some embodiments, the training dataset is generated from batches previously presented to the picker. Alternatively, the training dataset is generated from batches previously presented to pickers having one or more common characteristics as the picker. In other embodiments, the training dataset is generated from batches previously presented to multiple pickers of the online system. Each training example also has a label indicating whether the attrition event resulted from the training picker selecting the training batch. For example, the label has a specific value in response to the attrition event occurring from the training picker selecting the training batch and has an alternative value in response to the attrition event not occurring from the training picker selecting the training batch.

To train the batch outcome prediction model, the online system applies the batch outcome prediction model to each training example. Application of the batch outcome prediction model generates a predicted probability of displaying the training attribute of the training batch to the training picker resulting in the attrition event from the training picker selecting the training batch. The online system generates a score for the training example based on a difference between a label applied to the training example and the predicted probability determined for the training example. In various embodiments, the score comprises an error term determined based on application of a loss function to the label applied to the training example and the predicted probability. The online system backpropagates the score through the batch outcome prediction model to update the set of parameters comprising the batch outcome prediction model and stops backpropagation in response to the score, or to the loss function, satisfying one or more criteria.

The online system applies the batch outcome prediction model to characteristics of the picker, the attributes of the batch, and to each attribute of the set. Application of the batch outcome prediction module generates a probability of displaying each attribute of the set to the picker resulting in an attrition event from the picker selecting the batch. Hence, the probabilities determined by the batch outcome prediction model provide an indication of how awareness of different attributes of the set by the picker affects selection (and fulfillment) of the batch by the picker. This provides the online system with information about which attributes of the batch from the set optimize attributes of the batch displayed to the picker in a display area that reduces the likelihood of an attrition event occurring if the picker selects the batch. As picker client devices often have limited display area for presenting attributes about the batch, the determined probabilities for displaying different attributes of the set allows the online system to more efficiently present attributes of the batch in the limited display area so attributes most likely prevent an attrition event occurring from the picker selecting the batch are presented via the display area of a picker client device.

The online system selects one or more attributes of the set based on the determined probabilities. In various embodiments, the online system generates a ranking of the attributes of the set based on their corresponding probabilities. The ranking has attributes of the set with lower probabilities in higher positions of the ranking in various embodiments. Alternatively, the ranking has attributes of the set with lower probabilities in lower positions of the ranking. Based on the ranking, the online system selects one or more attributes. For example, the online system selects one or more attributes having at least a threshold position in the ranking. However, in other embodiments, the online system selects one or more attributes with corresponding probabilities satisfying one or more other criteria. Selecting one or more attributes based on their probabilities selects attributes most likely to prevent an attrition event from occurring if the picker selects the batch for presentation to the picker. As the batch outcome prediction model determines the probabilities based in part on characteristics of the picker, selecting one or more attributes based on the probabilities tailors one or more of the attributes presented to the picker based on characteristics of the picker, increasing visibility of certain attributes relevant to the picker via a display area of a picker client device.

The online system generates an interface identifying the selected one or more attributes of the batch for transmission to a picker client device of the picker. In various embodiments, the interface includes descriptive information about the batch and the selected one or more attributes of the batch. For example, the interface includes a specific group of attributes of the batch and visually distinguishes the selected one or more attributes from other attributes of the group, making the selected one or more attributes more noticeable to the picker. Alternatively, the online system generates the interface based on the ranking, with attributes presented by the interface or positioning of attributes in the interface based on the ranking.

In various embodiments, the interface includes a group of attributes of the batch that are predetermined or preselected by the online system. For example, the online system maintains a group of attributes that are presented by the interface for each batch. When generating the interface, the online system visually distinguishes one or more attributes selected based on probabilities determined by the batch outcome prediction model from other attributes of the group. For example, selected attributes are displayed in a different color or in a different font that the other attributes in the interface. As another example, additional interface elements are displayed proximately to selected attributes that are not displayed proximate to other attributes. Such visual differentiation between selected attributes and other attributes increases a likelihood of the picker reviewing the selected attributes via the interface when determining whether to select the batch.

In other embodiments, the online system includes the selected attributes in specific locations within the interface to increase a likelihood of the picker reviewing the selected attributes. For example, the interface has one or more specific locations allocated for displaying the selected attributes in locations where they are most likely to be visible to the picker. Alternatively, the online system dynamically identifies attributes and the one or more selected attributes for inclusion in the interface based on the ranking of attributes. For example, the online system selects attributes having at least a minimum position in a ranking based on corresponding probabilities for inclusion in the interface and selects one or more attributes having at least a threshold position in the ranking. The interface visually distinguishes the selected attributes from other attributes, while the online system dynamically selects attributes presented by the interface to the particular picker for whom the interface is generated. In other embodiments, the online system generates an interface displaying the group of attributes and generates a supplemental interface that includes the selected attributes. The interface includes an interface element that, when selected by the picker, retrieves and presents the supplemental interface to the picker.

Determining probabilities of presenting each attribute of the set resulting in the attrition event in response to the picker selecting the batch leverages characteristics of the picker and attributes of prior batches presented to the picker to identify certain attributes of the set more relevant to the picker determining whether to select the batch. Generating the interface based on the probabilities determined by the batch outcome prediction model more efficiently uses display area available for the interface on a picker client device by having selected attributes of the set readily identifiable to the picker via the display area, reducing an amount of interaction by the picker with the picker client device to locate and to review attributes of the batch highly relevant to the picker determining whether to select the batch. Reducing the amount of input from the picker also reduces an amount of time the picker client device displays one or more interfaces identifying attributes of the batch, which reduces an amount of power consumed by the picker client device when the picker evaluates one or more batches. As many picker client devices are mobile devices, this reduced power consumption from selecting one or more attributes of the batch for inclusion in the interface based on the probabilities determined by the batch outcome prediction model extends battery life for picker client devices that are mobile devices or otherwise powered by battery used by the picker.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for dynamically selecting one or more attributes of a batch to include in an interface generated for a picker to evaluate the batch, in accordance with one or more embodiments.

FIG. 4 illustrates a process flow diagram of a method for dynamically selecting one or more attributes of a batch to include in an interface generated for a picker to evaluate the batch, in accordance with one or more embodiments.

FIG. 5 illustrates an example interface identifying one or more attributes of a batch selected for a picker based on characteristics of the picker and attributes of the batch, in accordance with one or more embodiments.

### DETAILED DESCRIPTION

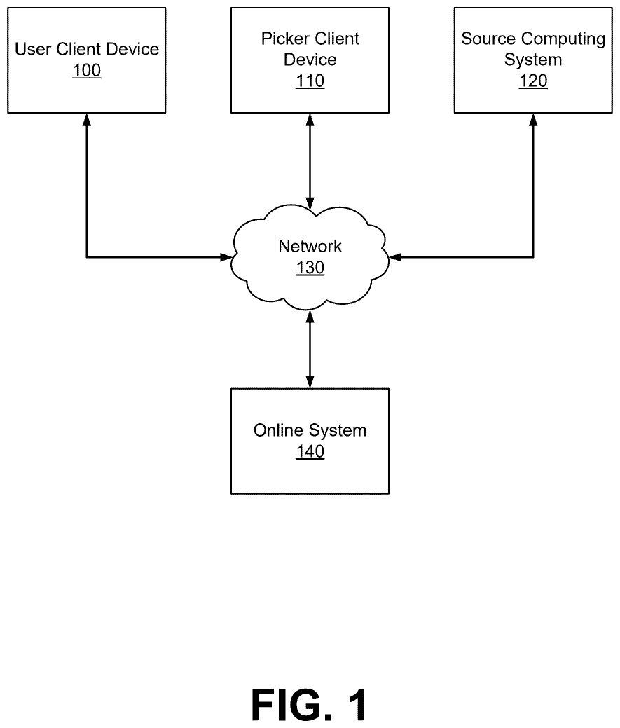

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

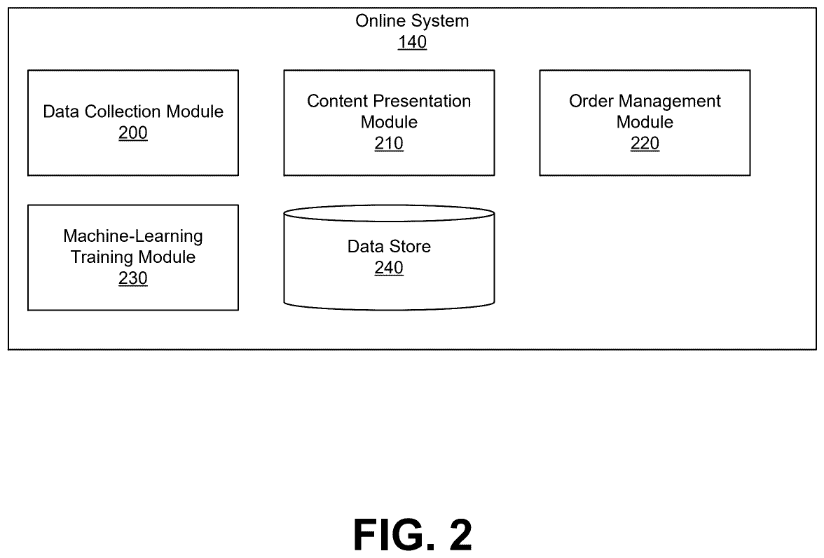

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

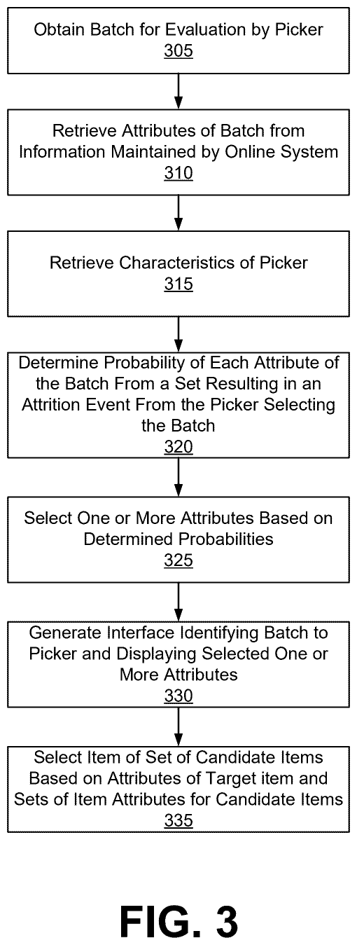

In various embodiments, the order management module 220 generates one or more batches that each include one or more orders. For example, a batch includes multiple orders having overlapping time intervals for delivery and identifying sources within a threshold distance of each other (or within a common geographic location). As another example, a batch includes multiple orders including a common source. The order management module 220 offers one or more batches to a picker, who determines whether to select a batch based on attributes of the batch. Attributes of the batch are based on attributes of orders included in the batch, as further described below in conjunction with FIG. 3.

To offer a batch to a picker, the order management module 220 generates an interface for a batch that includes a group of attributes of the batch. Based on the attributes of a batch included in the interface, a picker determines whether to select or not to select a batch for fulfillment. As different pickers emphasize different attributes of a batch when determining whether to select a batch and whether the picker fulfills the selected batch, the order management module 220 leverages a history of batches fulfilled by the picker and batches that the picker selected then subsequently canceled to tailor attributes of a batch that are included in an interface generated to the picker.

As further described below in conjunction with FIGS. 3-5, the order management module 220 applies a batch outcome prediction model to a combination of different attributes of a set, characteristics of a picker, and attributes of a batch. For an attribute of the set, the batch outcome prediction model determines a probability of an attrition event occurring in response to the picker selecting the batch when the attribute of the set is presented to the picker (e.g., included in an interface presenting attributes of the batch). In various embodiments, an attrition event comprises the picker selecting the batch then subsequently cancelling fulfillment of the batch. However, other events or various events may be a negative event in various embodiments. As further described below in conjunction with FIGS. 3-5, the order management module 220 selects one or more attributes of the set based on the probabilities determined by the batch outcome prediction model. For example, the order management module 220 selects one or more attributes of the set having less than a threshold probability or having minimum probabilities determined for attributes of the set, as further described below in conjunction with FIGS. 3-5.

The order management module 220 generates the interface for the batch so the one or more selected attributes of the set are visually distinguished from other attributes included in the interface or generates the interface to specifically include the one or more selected attributes for presentation to the picker. Accounting for the determined probabilities of an attrition event occurring in response to presenting different attributes of the set enables the order management module 220 to generate an interface for the picker presenting one or more attributes to the picker that reduce a likelihood of an attrition event occurring if the picker selects the batch. This allows the interface to more efficiently use display area available by picker client devices 110 to present attributes to the picker most relevant to the picker determining whether the batch can be fulfilled without an attrition event occurring.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

Further, the machine-learning training module 230 trains a batch outcome prediction model to generate a probability of an attrition event occurring in response to a picker selecting a batch when an attribute of the batch is presented to the picker. As further described below in conjunction with FIG. 3, the batch outcome prediction module receives an attribute of a set, characteristics of a picker, and attributes of a batch as inputs. The batch outcome prediction model determines a probability of an attrition event occurring in response to the picker selecting the batch when the attributes of the set are presented to the picker. The machine-learning training module 230 applies the batch outcome prediction model to each training example. Application of the batch outcome prediction model generates a predicted probability of displaying the training attribute of the training batch to the training picker resulting in the attrition event from the training picker selecting the training batch. The machine-learning training module 230 generates a score for the training example based on a difference between a label applied to the training example and the predicted probability determined for the training example. In various embodiments, the score comprises an error term determined based on application of a loss function to the label applied to the training example and the predicted probability. The machine-learning training module 230 updates a set of parameters comprising the batch outcome prediction model based on the score and stops backpropagation in response to the score, or to the loss function, satisfying one or more criteria, as further described below in conjunction with FIG. 3.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for dynamically selecting one or more attributes of a batch to include in an interface generated for a picker to evaluate the batch, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

An online system 140, such as an online concierge system, receives orders from various users. An order identifies one or more items as well as a source for obtaining the identified items. Further, the order may include information about fulfilling the order, such as a time interval for the user to receive items from the order and a location to which items are to be provided after being obtained from the identified source. Additional or alternative information may be included in the order in various embodiments.

To fulfill orders, the online system 140 identifies batches to one or more pickers, and a picker selects one or more batches to be fulfilled. The picker selecting a batch obtains items included in orders comprising the batch and delivers the obtained items to corresponding locations identified in the orders comprising the batch. In various embodiments, the online system 140 generates various batches corresponding to different groups of one or more orders received from users. For example, a batch includes orders that each identify a common source or that each identify sources within a threshold distance of each other; however, in various embodiments, orders included in a batch have different or additional common attributes.

The online system 140 generates an interface for a batch that presents attributes of the batch to a picker. Based on attributes of a batch presented by the interface, the picker determines whether to select the batch for fulfillment. In various embodiments, the online system 140 generates a different interface for each batch, with an interface generated for a batch including at least a subset of attributes of the batch. Viewing interfaces generated for different batches allows a picker to review attributes of different batches to determine whether to select one or more batches for fulfillment. In various embodiments, the online system 140 generates an interface for each batch eligible to be selected by a picker (e.g., each batch including orders in a geographic region including the picker, etc.).

However, different attributes of a batch influence whether different pickers select the batch. For example, certain pickers may determine whether to select a batch based on delivery instructions for delivering obtained items in orders of the batch to one or more locations included in the batch, while other pickers are not influenced by such delivery instructions when evaluating whether to select the batch. Similarly, a total weight of items included in a batch may determine whether some pickers select the batch, while other pickers determine whether to select the batch based on a number of items in the batch where a picker performs specific interactions in a source to obtain one or more items.

Conventional systems typically display a common group of attributes of a batch in interfaces generated for different batches. For example, the online system 140 determines a common group of attributes of a batch to display in the interface, so an interface for each batch presents the common group of attributes to various pickers. While presenting the common group of attributes simplifies generation of an interface for each batch, the common group of attributes in the interface may omit or obscure certain attributes relevant to specific pickers determining whether to select a batch. As many pickers view interfaces describing batches on picker client devices 110 with limited display areas, such as mobile device, displaying the common group of attributes to each picker inefficiently uses the limited display area and may prevent a specific picker from identifying attributes most relevant to the specific picker determining whether to select a batch. To view relevant attributes of a batch in conventional systems, a picker navigates through multiple interfaces, increasing an amount of content a picker client device 110 displays, increasing an amount of time the picker client device 110 displays content, which increases power consumption by the picker client device 110 while the picker determines whether to select a batch.

To more efficiently present attributes of a batch to a picker through a display area of a picker client device 110, the online system 140 obtains 305 a batch for evaluation by a picker. For example, the online system 140 obtains 305 a batch having one or more attributes satisfying one or more criteria specified by the picker. For example, the online system 140 receives a search query from a picker and obtains 305 a batch having attributes that at least partially match the received search query. As an example, the online system 140 receives a search query specifying a source or a geographic location and obtains 305 a batch having orders including the source or identifying the geographic location. In other embodiments, the online system 140 obtains 305 a batch including orders received from one or more users within a threshold amount of time from a time when the picker accesses the online system 140 or including orders received during a specific time interval. The obtained batch has one or more attributes making it eligible to be selected by the picker.

The online system 140 retrieves 310 attributes of the batch based on information maintained by the online system 140. Various attributes of the batch are based on attributes of orders included in the batch. Attributes of the batch include batch item attributes of items included in the batch. Example batch item attributes include: a number of unique items in the batch, a total number of units of items included in the batch, a total weight of items included in the batch, a total volume of items included in the batch, a number of items in the batch obtained through specific interactions within the source (e.g., obtained from an individual within the source, obtained through providing specific information to the source), a number of items in the batch that are fragile, or other attributes describing items included in the batch. Other attributes of the batch may be acquisition attributes describing acquisition of items in the batch by the picker. Example acquisition attributes include: an estimated amount of time for the picker to fulfill the batch, features of one or more locations for delivering items in the batch (e.g., an indication whether a location is an apartment, whether a location includes stairs or an elevator), an amount of interaction with one or more users when delivering items in the batch (e.g., an indication whether the picker interacts with the user from whom an order in the batch was received when delivering items to a location in the order), a total amount of compensation to the picker for fulfilling the batch, an amount the picker receives from one or more users having orders included in the batch for fulfilling the batch, an amount the picker receives from the online system 140 for fulfilling the batch, or other information describing acquisition of items in the batch by the picker. In various embodiments, different or additional attributes of the batch may be retrieved 310.

In some embodiments, the online system 140 retrieves 310 each attribute maintained for the batch. However, in other embodiments, the online system 140 retrieves 310 a subset of attributes maintained for the batch that is less than each attribute maintained for the batch. In different embodiments, the online system 140 may retrieve 310 different subsets of attributes maintained for the batch.

Additionally, the online system 140 retrieves 315 characteristics of the picker, including a history of prior batches presented to the picker. The history of prior batches includes an entry for each prior batch presented to the picker. An entry for a prior batch includes an indication whether the picker selected or did not select (or rejected) the prior batch and information describing the prior batch. For example, the entry for a prior batch includes information identifying the prior batch and a specific value in response to the picker selecting the prior batch or an alternative value in response to the picker not selecting the prior batch. Information identifying the prior batch may be an identifier of the prior batch or attributes of the prior batch. In some embodiments, an entry for the prior batch presented to the picker includes an indication whether the picker selected the prior batch and includes an amount of time between the prior batch being presented to the picker to the picker selecting the prior batch (or rejecting the prior batch). In some embodiments, characteristics of the picker include an average amount of time between the picker being presented with a batch and the picker selecting the batch (or rejecting the batch).

In some embodiments, the online system 140 prompts the picker to identify one or more attributes of a prior batch that caused the picker to not select the prior batch (i.e., that caused the picker to reject the prior batch). For example, the online system 140 prompts the picker to identify one or more attributes of a batch that caused the picker to not select the batch in response to the online system 140 receiving an input from the picker rejecting the batch. However, in other embodiments, the online system 140 presents a prompt to the picker to identify one or more attributes of a prior batch that the picker did not select in response to one or more other criteria being satisfied. The online system 140 includes the identified one or more attributes of the prior batch in the entry for the prior batch in the history of prior batches, augmenting the history of prior batches with attributes of a prior batch that caused the picker to not select the prior batch.

In various embodiments, characteristics of the picker include a cancellation history of the picker. The cancellation history includes previous batches that the shopper selected for fulfillment and cancelled after selection. For example, the cancellation history includes information identifying a previous batch that the picker selected and subsequently cancelled after selection. Information identifying the previous batch may include attributes of the previous batch, such as batch item attributes or acquisition attributes, as further described above.

Further, in some embodiments characteristics of the picker include one or more reasons the picker canceled a previous batch or did not select a prior batch. The online system 140 determines a reason for the picker cancelling a previous batch that the picker selected based on a chat history for the previous batch including messages between the picker and a user from whom an order in the previous batch was received. From one or more messages in the chat history, the online system 140 identifies one or more attributes of the previous batch having at least a threshold probability of causing the picker to cancel fulfillment of the previous batch. The online system 140 includes the one or more identified attributes of the previous batch in the cancellation history in association with the previous batch to identify one or more attributes of the previous batch causing the picker to cancel fulfillment of the previous batch.

The online system 140 applies a batch outcome prediction model to each of at least a set of attributes of the batch. Application of the batch outcome prediction model to an attribute of the set determines 320 a probability that displaying the attribute of the set to the picker, such as through an interface, results in an attrition event from the picker selecting the batch. For example, an attrition event is the picker selecting the batch and cancelling fulfillment of the batch after selecting the batch. As another example, the attrition event is the online system 140 receiving negative feedback from a user who provided an order included in the batch about fulfillment of the order. However, in other embodiments, different events comprise the attrition event from the picker fulfilling the batch. Multiple events may be considered an attrition event for the batch outcome prediction model, allowing the batch outcome prediction model to account for different events affecting a batch. The batch outcome prediction model receives the attribute of the set, attributes of the batch, and characteristics of the picker as input and determines 320 the probability that displaying the attribute of the set to the picker results in the attrition event from the picker selecting the batch.

The online system 140 trains the batch outcome prediction model based on a training dataset including multiple training examples. Each training example includes a training attribute, a set of training attributes for a training batch, and training characteristics of a training picker. In some embodiments, the training dataset is generated from batches previously presented to the picker. Alternatively, the training dataset is generated from batches previously presented to pickers having one or more common characteristics as the picker. In other embodiments, the training dataset is generated from batches previously presented to multiple pickers of the online system 140. Each training example also has a label indicating whether the attrition event resulted from the training picker selecting the training batch. For example, the label has a specific value in response to the attrition event occurring from the training picker selecting the training batch and has an alternative value in response to the attrition event not occurring from the training picker selecting the training batch.

To train the batch outcome prediction model, the online system 14f0 initializes a set of weights comprising the batch outcome prediction model and applies the batch outcome prediction model to multiple training examples of the training dataset. Applying the batch outcome prediction model to multiple training examples updates the parameters (e.g., the weights) comprising the batch outcome prediction model. The parameters comprising the batch outcome prediction model transform the input data—the attribute of the set, the attributes of the batch, and the characteristics of a picker—into a probability of displaying an attribute of the set of attributes of the batch to the picker resulting in an attrition event from the picker selecting the batch. When applied to a training example, the batch outcome prediction model generates a predicted probability of displaying the training attribute of the training batch to the training picker resulting in the attrition event from the training picker selecting the training batch.

For each training example to which the batch outcome prediction model is applied, the online system 140 generates a score comprising an error term based on the predicted probability of displaying the training attribute of the training batch to the training picker resulting in the attrition event from the training picker selecting the training batch and the label applied to the training example. The error term is larger when a difference between the predicted probability of displaying the training attribute of the training batch to the training picker resulting in the attrition event from the training picker selecting the training batch and the label applied to the training example is larger. Similarly, the error term is smaller when the difference between the predicted probability of displaying the training attribute of the training batch to the training picker resulting in the attrition event from the training picker selecting the training batch and the label applied to the training example is smaller. In various embodiments, the online system 140 generates the error term using a loss function based on a difference between the predicted probability of displaying the training attribute of the training batch to the training picker resulting in the attrition event from the training picker selecting the training batch and the label applied to the training example using a loss function. Example loss functions include a mean square error function, a mean absolute error, a hinge loss function, and a cross-entropy loss function.

The online system 140 backpropagates the error term to update the set of parameters comprising the batch outcome prediction model and stops backpropagation in response to the error term, or to the loss function, satisfying one or more criteria. For example, the online system 140 backpropagates the error term through the batch outcome prediction model to update parameters of the batch outcome prediction model until the error term has less than a threshold value. For example, the online system 140 may apply gradient descent to update the set of parameters. The online system 140 stores the set of parameters comprising the batch outcome prediction model on a non-transitory computer readable storage medium after stopping the backpropagation.

For each attribute of the set, the online system 140 determines 320 the probability of displaying an attribute of the set to the picker resulting in an attrition event from the picker selecting the batch using the batch outcome prediction model. In some embodiments, the set of attributes includes each attribute of the batch. Alternatively, the set of attributes includes a subset of the attributes of the batch for which the probability of displaying an attribute of the set to the picker resulting in an attrition event from the picker selecting the batch is determined 320.

Based on the determined probabilities for attributes of the set, the online system 140 selects 325 one or more attributes of the set. In some embodiments, the online system 140 ranks the attributes of the set based on the determined probabilities and selects 325 one or more attributes having at least a threshold position in the ranking. For example, the online system 140 ranks attributes of the set so attributes of the set with lower determined probabilities have higher positions in the ranking and selects 325 attributes having at least a threshold position in the ranking. As another example, the online system 140 ranks attributes of the set so attributes of the set with lower determined probabilities have lower positions in the ranking and selects 325 attributes having less than a threshold position in the ranking. In other embodiments, the online system 140 selects 325 one or more attributes having less than a threshold determined probability.

Hence, the selected attributes of the set result in the lowest determined probability of an attrition event occurring from the picker selecting the batch when displayed. So, the selected attributes are attributes of the batch least likely to result in an attrition event occurring during fulfillment when displayed to the picker when describing the batch. Hence, presenting the selected attributes in the picker is most likely to prevent an attrition event from occurring if the picker selects the batch, as the selected attributes are those resulting in a minimum likelihood of an attrition event from the picker when the picker is aware of the selected attributes. As the batch outcome prediction model accounts for characteristics of the picker and attributes of the batch, selecting 325 attributes of the batch based on the determined probabilities tailors attribute selection to a particular picker, so the selected attributes are relevant to the picker.

The online system 140 generates 330 an interface identifying the batch to the picker based on the selected attributes. In some embodiments, the online system 140 visually differentiates the selected attributes in the interface from other attributes in the interface to increase a likelihood of the picker identifying the selected attributes in the interface. For example, the online system 140 generates 330 the interface so the selected attributes are displayed in a different font, in a different color, or in a different format than other attributes. However, in other embodiments, the online system 140 modifies one or more other visual characteristics of the selected attributes to differentiate the selected attributes from other attributes in the interface. For example, the online system 140 includes a particular group of attributes of the batch in the interface, so an interface generated 330 for different batches includes the particular group of attributes. The online system 140 visually distinguishes the selected attributes from other attributes of the particular group included in the interface.

As another example, the online system 140 generates 330 an interface for the batch including the particular group of attributes and generates 330 a supplemental interface including one or more of the selected attributes. For example, the supplemental interface includes selected attributes that are not included in the particular group of attributes. The interface for the batch includes a link or other interface element that, when selected by the picker, obtains the supplemental interface from the online system 140 for presentation to the selected attributes to the picker. Generating the supplemental interface provides the picker with attributes of the batch specifically selected 325 for the picker to allow the picker to review attributes most likely relevant to the picker successfully fulfilling the batch, while presenting the particular group of attributes to each picker via the interface generated 330 for the batch.

In other embodiments, the online system 140 generates 330 a picker-specific interface for the picker including the selected attributes. Generating the picker-specific interface tailors the presented attributes of the batch to the picker, by resulting an interface that optimizes use of a display area of a picker client device 110 to present the picker with attributes of the batch most relevant to the picker accurately determining whether the picker can successfully fulfill the batch after selection. In other embodiments, other types of interfaces may be generated 330.

The online system 140 transmits 335 the interface to a picker client device 110 for presentation to the picker. Based on attributes of the batch displayed by the interface including the selected attributes, the picker determines whether to select the batch for fulfillment by the picker or to not select the batch for fulfillment by the picker. In various embodiments, the picker performs a selection interaction with the interface (e.g., a specific gesture, selection of a specific interface element in the interface) via the picker client device 110 to select the batch, and the picker client device 110 transmits a batch acceptance message to the online system 140, which associates the batch with the picker and prevents the online system 140 from subsequently identifying the batch to other pickers. Subsequently, the picker obtains items included in the batch and provides the items to one or more locations specified by the batch. Alternatively, the picker performs a rejection interaction to decline selecting the batch via the interface. In some embodiments, in response to receiving the rejection interaction, the online system generates 330 an interface for an additional batch, as further described above, and transmits 335 the interface for the additional batch to the picker client device 110 for presentation to the picker.

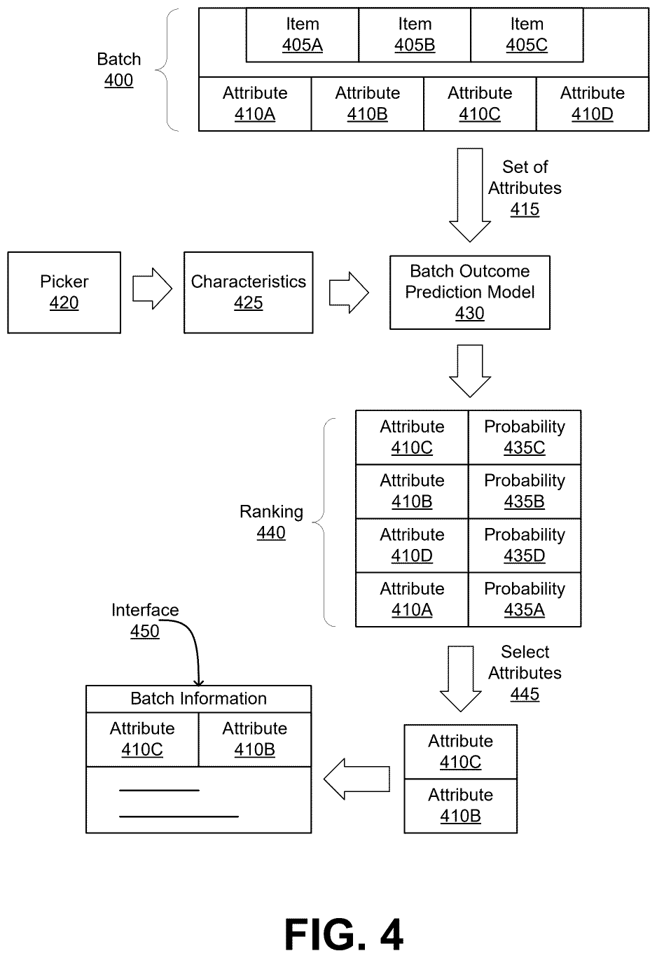

FIG. 4 is a process flow diagram of a method for dynamically selecting one or more attributes of a batch to include in an interface generated for a picker to evaluate the batch, in accordance with one or more embodiments. As further described above in conjunction with FIG. 3, an online system 140, such as an online concierge system, receives orders from various users. An order identifies one or more items as well as a source for obtaining items in the order. The order may include information about fulfilling the order, such as a time interval for the user to receive items from the order and a location to which items from the order are to be provided after being obtained from the identified source.

The online system 140 identifies one or more batches of orders to pickers, who determine whether to select a batch based on attributes of the batch. A batch includes one or more orders, and the online system 140 may determine orders to include in a batch based on attributes of the orders. For example, a batch includes multiple orders identifying a common source or includes multiple orders that identify different sources within a threshold distance of each other. However, a batch may include a single order. When a picker selects a batch via the online system 140, the picker subsequently obtains items from one or more sources identified by orders in the selected batch and delivers the items to locations identified by the orders in the selected batch.

When identifying a batch to a picker, the online system 140 generates an interface presenting at least a group of attributes of the batch to the picker. The group comprises a subset of attributes of the batch in various embodiments, which reduces a number of attributes of the batch presented to the picker. Based on the attributes of the batch presented by the interface, the picker determines whether to select the batch. The online system 140 generates and presents an interface for different batches, such as an interface for each batch associated with a geographic location including the picker that is not allocated to a picker. While the subset of attributes of a batch presented by an interface allows a picker to evaluate a batch for selection, different attributes of a batch differently influence different pickers whether to select the batch. For example, a total weight of items included in a batch may determine whether a specific picker selects the batch, while another picker determines whether to select the batch based on a number of items in the batch obtained by the picker performing specific interactions in a source rather than the total weight of items in the batch. Conventional online systems include a common group of attributes of a batch, comprising a subset of attributes of the batch, in interfaces generated for different pickers, which prevents conventionally generated interfaces presented to different pickers from accounting for picker-specific emphasis on different attributes when identifying attributes of a batch to different pickers.

To more efficiently present attributes of a batch to a picker via a display area of a picker client device 110, the online system 140 obtains a batch 400 for evaluation by a picker. The batch 400 is eligible to be selected by the picker evaluating the batch; for example, the batch 400 includes sources that are in a geographic location including the picker. As further described above, the batch 400 includes one or more items 405A, 405B, 405C (also referred to individually and collectively using reference number 405) and has various attributes 410A, 410B, 410C, 410D (also referred to individually or collectively using reference number 410). For example, the batch 400 has attributes 410 that at least partially match a search query received from a user. As another example, the batch was received by the online system 140 within a threshold amount of time from a time when a picker accessed the online system 140 or was received by the online system 140 during a specific time period.

Attributes 410 of the batch 400 include batch item attributes of items included in the batch. Example batch item attributes include: a number of unique items in the batch 400, a total number of units of items included in the batch 400, a total weight of items included in the batch 400, a total volume of items included in the batch 400, a number of items in the batch 400 obtained through specific interactions within a source identified by the batch 400 (e.g., obtained from an individual within the source, obtained through providing specific information to the source), a number of items in the batch 400 that are fragile, or other attributes describing items included in the batch 400. Other attributes 410 of the batch 400 may be acquisition attributes that describe acquisition of items 405 by the picker. Example acquisition attributes include: an estimated amount of time for the picker to fulfill the batch 400, features of one or more locations for delivering items in the batch 400 (e.g., an indication whether a location is an apartment, whether a location includes stairs or an elevator), an amount of user interaction when delivering items in the batch 400 (e.g., an indication whether the picker interacts with the user from whom an order in the batch 400 was received when delivering items to a location in the order), a total amount of compensation to the picker for fulfilling the batch 400, an amount the picker receives from one or more users having orders included in the batch 400 for fulfilling the batch, an amount the picker receives from the online system 140 for fulfilling the batch 400, or other information describing acquisition of items in the batch 400 by the picker. However, the batch 400 may have different or additional attributes 410 in various embodiments.

The online system 140 retrieves the attributes 410 of the batch 400 from stored information describing the batch 400. Additionally, the online system 140 identifies a set 415 of attributes 410 of the batch 400. For example, the set 415 of attributes 410 of the batch 400 includes a specific number of attributes 410 of the batch 400. In different embodiments, the set 415 may include different numbers of attributes 410 of the batch 400. Alternatively, the set 415 of attributes of the batch 400 includes all attributes 410 of the batch 400. The set 415 of attributes 410 may be predetermined by the online system 140 in some embodiments; alternatively, the online system 140 identifies the set 415 of attributes 410 based on prior selection of orders by pickers or based on other information. Specific attributes 410 of the batch 400 are included in the set 415 in various embodiments.

The online system 140 also identifies a picker 420 to whom information about the batch 400 is to be presented and retrieves characteristics 425 of the picker 420 based on information maintained by the online system 140. A characteristic 425 of the picker includes a history of prior batches presented to the picker. As further described above in conjunction with FIG. 3, the history of prior batches includes an entry for each prior batch presented to the picker. The entry for a prior batch includes an indication whether the picker selected or did not select the prior batch. In some embodiments, the history of prior batches presented to the picker 420 includes an amount of time from a prior batch being presented to the picker to the picker selecting (or rejecting) the prior batch. Another example characteristic 425 of the picker 420 is an average amount of time between the picker being presented with a batch and the picker 420 selecting (or rejecting) the batch in some embodiments. The online system 140 may prompt the picker to identify one or more attributes of a prior batch that caused the picker to reject the prior batch and include the one or more identified attributes in the history of prior batches in association with the prior batch.

In various embodiments, the characteristics 425 of the picker 420 include a cancellation history of the picker 420 including previous batches that the picker 420 selected for fulfillment and cancelled after selection. For example, the cancellation history includes attributes of a previous batch that the picker 420 cancelled after selecting, such as batch item attributes or acquisition attributes, as further described above in conjunction with FIG. 3. Different or additional attributes of or information about a previous batch that the picker 420 cancelled after selection may be included in the cancellation history in various embodiments. Characteristics 425 of the picker 420 may include one or more reasons for the picker cancelling a previous batch or not selecting a prior batch. In some embodiments, the online system 140 determines a reason for the picker 420 cancelling a previous batch after selection based on a chat history for the previous batch including messages between the picker and a user from whom the previous batch was received. The online system 140 identifies one or more attributes of the previous batch having at least a threshold probability of causing the picker to cancel fulfillment of the previous batch from the chat history for the previous batch in various embodiments. The online system 140 includes the one or more identified attributes of the previous batch in the cancellation history in association with the previous batch to identify one or more attributes of the previous batches causing cancellation of fulfillment of the previous batch by the picker 420.

The online system 140 applies a batch outcome prediction model 430 to the characteristics 425 of the picker 420, the attributes 410 of the batch, and an attribute of the set 415. As further described above in conjunction with FIG. 3, the batch outcome prediction model 430 is trained to generate a probability of displaying an attribute of the set 415 of attributes of the batch 400 to the picker 420 resulting in an attrition event from the picker 420 selecting the batch 400. In various embodiments, an attrition event from the picker 420 selecting the batch 400 comprises the picker 420 cancelling fulfillment of the batch 400 after selecting the batch 400. However, in other embodiments, an attrition event comprises the online system 140 receiving negative feedback about fulfillment of an order from the batch or one or more other events specified by the online system 140. Multiple events comprise an attrition event in some embodiments, allowing the batch output prediction model 430 to account for different types of potential attrition events.

In the example of FIG. 4, the set 415 includes attributes 410A-D; however, in other embodiments, the set 415 includes a limited number of attributes 410 of the batch 400. The online system 140 applies the batch outcome prediction model 430 to characteristics 425 of the picker 420, the attributes 410 of the batch, and each of attribute 410A, attribute 410B, attribute 410C, and attribute 410D. Application of the batch outcome prediction module 430 generates probability 435A of displaying attribute 410A to the picker 420 resulting in an attrition event from the picker 420 selecting the batch 400 and probability 435B of displaying attribute 410B to the picker 420 resulting in an attrition event from the picker 420 selecting the batch 400. Similarly, the batch outcome prediction model 430 determines probability 435C of displaying attribute 410C to the picker 420 resulting in an attrition event from the picker 420 selecting the batch 400 and determines probability 435D of displaying attribute 410D to the picker 420 resulting in an attrition event from the picker 420 selecting the batch 400.

Applying the batch outcome prediction model 430 to each attribute 410 of the set 415 determines a probability of displaying each attribute 410 of the set 415 to the picker resulting in an attrition event if the picker 420 selects the batch 400. Hence, the probabilities determined by the batch outcome prediction model provide an indication of how awareness of different attributes 410 of the batch 400 by the picker 420 affects selection (and fulfillment) of the batch by the picker 420. This provides the online system 140 with information about which attributes 410 of the batch 400 to optimize attributes 410 of the batch 400 displayed to the picker 420 in a display area that reduces a likelihood of an attrition event occurring if the picker 420 selects the batch 400. As picker client devices 110 often have limited display area for presenting attributes about the batch 400, the determined probabilities 435A-D for displaying different attributes 410 of the set 415 allows the online system 140 to more efficiently present attributes 410 of the batch 400 in the limited display area so attributes 410 most likely prevent an attrition event occurring from the picker 420 selecting the batch 400 are presented via the display area of a picker client device 110.

In various embodiments, the online system 140 generates a ranking 440 of the attributes 410 of the set 415 based on their corresponding probabilities 435A-D. In some embodiments, the ranking 440 has attributes 410 of the set 415 with lower probabilities 435A-D in higher positions of the ranking 440. Alternatively, the ranking 440 has attributes 410 of the set 415 with lower probabilities 435A-D in lower positions of the ranking 440. For purposes of illustration, FIG. 4 shows an example where the ranking 440 has attributes 410 of the set 415 with lower probabilities 435A-D in higher positions. In the example of FIG. 4, attribute 410C has the lowest probability 435C, attribute 410B has the second lowest probability 435B, attribute 410D has the third lowest probability 435D, while attribute 410C has the highest probability 435D.

Based on the ranking 440, the online system 140 selects 445 one or more attributes 410. For example, the online system 140 selects 445 one or more attributes 410 having at least a threshold position in the ranking. In the example of FIG. 4, the online system 140 selects 445 attributes 410 having at least a second position in the ranking 440, so the online system 140 selects 445 attribute 410C and attribute 410B. However, in other embodiments, the online system 140 selects 445 one or more attributes 410 with corresponding probabilities 435A-D satisfying one or more other criteria. Selecting 445 one or more attributes 410 based on their probabilities 435A-D selects attributes 410 most likely to prevent an attrition event from occurring if the picker 420 selects the batch 400 for presentation to the picker 420. As the batch outcome prediction model 430 determines the probabilities 435A-D based in part on characteristics of the picker 420, selecting 445 one or more attributes 410 based on the probabilities 435A-D tailors one or more of the attributes 410 presented to the picker 420 based on characteristics of the picker 420, increasing visibility of certain attributes 410 relevant to the picker 420 via a display area of a picker client device 110.

The online system 140 generates an interface 450 identifying the selected one or more attributes 410 of the batch 400 for transmission to a picker client device 110 of the picker 420. In various embodiments, the interface 450 includes descriptive information about the batch 400 and the selected one or more attributes 410 of the batch. For example, the interface 450 includes a specific group of attributes 410 of the batch 400 and visually distinguishes the selected one or more attributes 410 from other attributes 410 of the group, making the selected one or more attributes 410 more noticeable to the picker 420. Alternatively, the online system 140 generates the interface 450 based on the ranking 440, with attributes 410 presented by the interface 450 or positioning of attributes 410 in the interface 450 based on the ranking 440.

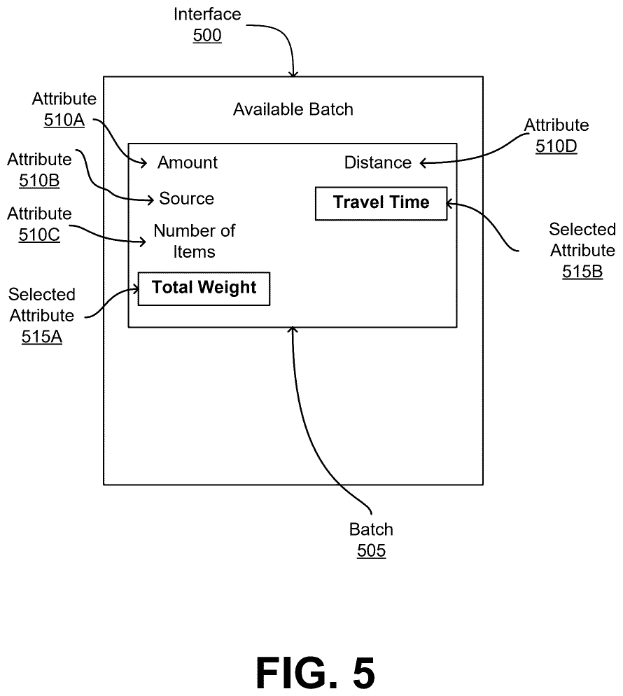

Referring to FIG. 5, an example interface 500 generated based on one or more attributes of a batch selected for a picker is shown. In the example of FIG. 5, the interface 500 includes attributes of a batch 505 for presentation to a picker. The interface 500 includes various attributes 510A-D (also referred to individually or collectively using reference number 510) of the batch 505 that are predetermined or preselected by the online system 140 in various embodiments. For example, the online system 140 maintains a group of attributes 510 that are presented by the interface 500 for each batch. In the example of FIG. 5, the attributes 510 include an amount the picker receives for fulfilling the batch 505, a source from which the picker obtains items for the batch 505, a number of items included in the batch 505, and a distance for the picker to travel from a source to a location identified by the batch 505.

As further described above in conjunction with FIGS. 3 and 4, the online system 140 selects one or more attributes of the batch 505 based on probabilities of displaying different attributes 510 of a set resulting in an attrition event in response to the picker selecting the batch 505. For example, the online system 140 applies a trained batch outcome prediction model to different attributes 510 of a set, and the batch outcome prediction model determines a probability of displaying an attribute 510 via the interface 500 resulting in the picker selecting the batch 505 then subsequently cancelling fulfillment of the batch 505. However, the batch outcome prediction model may determine a pliability of one or more other negative events occurring when an attribute 410 is presented via the interface 500 in various embodiments. In various embodiments, the online system 140 selects attributes 510 having minimum probabilities of resulting in an attrition event when displayed to the picker. Selecting one or more attributes with minimum probabilities of resulting in an attrition event when displayed to the picker selects attributes 510 of the batch 505 to present that reduces a likelihood of the picker having an attrition event when aware of the attributes via the interface 500.

In the example of FIG. 5, the online system 140 selects two attributes 510 based on their probabilities resulting in an attrition event in response to the picker selecting the batch 505 when displayed. However, in other embodiments, the online system 140 selects any number of attributes 510 based on their probabilities. In the example of FIG. 5, selected attribute 515A and selected attribute 515B are visually distinguished from other attributes 510 of the batch 505 presented by the interface 500. For example, selected attribute 515A and selected attribute 515B are displayed in a different color or in a different font than the other attributes 510 in the interface 500. As another example, additional interface elements are displayed proximate to selected attribute 515A and selected attribute 515B that are not displayed proximate to other attributes 510. Such visual differentiation between selected attributes 515A, 515B and other attributes 510 increases a likelihood of the picker reviewing the selected attributes 515A, 515B via the interface 500 when determining whether to select the batch 505.

In other embodiments, the online system 140 includes the selected attributes 515A, 515B in specific locations within the interface 500 to increase a likelihood of the picker reviewing the selected attributes 515A, 515B. For example, the interface 500 has one or more specific locations allocated for displaying the selected attributes 515A, 515B in locations where they are most likely to be visible to the picker. Alternatively, the online system 140 dynamically identifies attributes 510 and the one or more selected attributes 515A, 515B for inclusion in the interface 500 based on the ranking of attributes 510. For example, the online system 140 selects attributes 510 having at least a minimum position in a ranking based on corresponding probabilities for inclusion in the interface 500 and selects one or more attributes having at least a threshold position in the ranking. The interface visually distinguishes the selected attributes 515A, 515B from other attributes 510, while the online system 140 dynamically selects attributes 510 presented by the interface 500 to the particular picker for whom the interface 500 is generated.

Referring back to FIG. 4, determining probabilities 435A-D of presenting each attribute 410 of the set 415 resulting in the attrition event in response to the picker selecting the batch 400 leverages characteristics of the picker 420 and attributes of prior batches presented to the picker 420 to identify certain attributes 410 of the set 415 more relevant to the picker 420 determining whether to select the batch 400. Generating the interface 450 based on the probabilities 425A-D more efficiently uses display area available for the interface 450 on a picker client device 110 by having selected attributes 410 of the set 415 readily identifiable to the picker via the display area, reducing an amount of interaction by the picker 420 with the picker client device 110 to locate and to review attributes 410 of the batch 400 highly relevant to the picker 420 determining whether to select the batch 400. Reducing the amount of input from the picker 420 also reduces an amount of time the picker client device 110 displays one or more interfaces identifying attributes 410 of the batch, which reduces an amount of power consumed by the picker client device 110 when the picker 420 evaluates one or more batches. As many picker client devices 110 are mobile devices, this reduced power consumption from selecting 445 one or more attributes 410 of the batch 400 for inclusion in the interface 450 based on the probabilities 425A-D extends battery life for picker client devices 110 that are mobile devices or otherwise powered by battery used by the picker 420.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
obtaining a batch for evaluation by a picker of the computer system, the batch including one or more orders;
retrieving attributes of the batch maintained by the computer system;
retrieving characteristics of the picker maintained by the computer system;
for each of at least a set of attributes of the batch, determining a probability of displaying an attribute of the set of attributes of the batch to the picker resulting in an attrition event from the picker selecting the batch by applying a batch outcome prediction model to the characteristics of the picker, the attribute of the set, and the attributes of the batch, the batch outcome prediction model trained by:
obtaining a training dataset including a plurality of training examples, each training example including a training attribute, training attributes for a training batch, and training characteristics of a training picker, each training example having a label indicating whether the attrition event resulted from the training picker selecting the training batch;
applying the batch outcome prediction model to each training example of the training dataset to generate a predicted probability of the training attribute resulting in the attrition event from the training picker selecting the training batch for fulfillment;
scoring the batch outcome prediction model using a loss function applied to the predicted probability of the training attribute and the label of the training example; and
updating one or more parameters of the batch outcome prediction model by backpropagation based on the scoring until one or more criteria are satisfied;
selecting one or more attributes of the set based on the determined probabilities; and
generating an interface identifying the selected one or more attributes of the set for transmission to a picker client device of the picker.

2. The method of claim 1, wherein selecting one or more attributes of the set based on the determined probabilities comprises:
ranking the attributes of the set based on the determined probabilities; and
selecting one or more attributes of the set having at least a threshold position in the ranking.

3. The method of claim 2, wherein ranking the attributes of the set based on the determined probabilities comprises ranking attributes of the set with lower determined probabilities to have higher positions in the ranking.

4. The method of claim 1, wherein generating the interface identifying the selected one or more attributes of the set for transmission to a picker client device of the picker comprises:
generating an interface identifying each of a group of attributes of the batch, the interface visually distinguishing the selected one or more attributes of the set from other attributes of the group.

5. The method of claim 1, wherein generating the interface identifying the selected one or more attributes of the set for transmission to a picker client device of the picker comprises:
generating an interface identifying each of a group of attributes of the batch and including an interface element that, when selected by the picker obtains a supplemental interface including the selected one or more attributes of the set from the computer system.

6. The method of claim 1, wherein retrieving attributes of the batch comprises retrieving one or more of: a number of unique items in the batch, a total number of units of items included in the batch, a total weight of items included in the batch, a total volume of items included in the batch, a number of items in the batch obtained through specific interactions within a source identified by the batch, a number of items in the batch that are fragile, or any combination thereof.

7. The method of claim 1, wherein retrieving attributes of the batch comprises retrieving one or more of: an estimated amount of time for the picker to fulfill the batch, features of one or more locations for delivering items in the batch, an amount of user interaction by the picker with a user when delivering items in the batch, a total amount of compensation to the picker for fulfilling the batch, an amount the picker receives from one or more users having orders included in the batch for fulfilling the batch, an amount the picker receives for fulfilling the batch, or any combination thereof.

8. The method of claim 1, wherein retrieving characteristics of the picker comprises retrieving a history of prior batches presented to the picker, the history of prior batches including attributes of a prior batch, and an indication whether the picker selected the prior batch.

9. The method of claim 8, wherein the history of prior batches includes one or more attributes of a prior batch that the picker did not select that caused the picker to not select the prior batch.

10. The method of claim 1, wherein characteristics of the picker maintained by the computer system include a cancellation history including previous batches that the picker selected and canceled after selection and one or more identified attributes of a prior batch causing the picker to cancel fulfillment of the prior batch.

11. A computer program product comprising a non-transitory computer readable storage medium having instructions encoded thereon that, when executed by a processor, cause the processor to perform steps comprising:
obtaining a batch for evaluation by a picker of an online system, the batch including one or more orders;
retrieving attributes of the batch maintained by the online system;
retrieving characteristics of the picker maintained by the online system;
for each of at least a set of attributes of the batch, determining a probability of displaying an attribute of the set of attributes of the batch to the picker resulting in an attrition event from the picker selecting the batch by applying a batch outcome prediction model to the characteristics of the picker, the attribute of the set, and the attributes of the batch, the batch outcome prediction model trained by:
obtaining a training dataset including a plurality of training examples, each training example including a training attribute, training attributes for a training batch, and training characteristics of a training picker, each training example having a label indicating whether the attrition event resulted from the training picker selecting the training batch;
applying the batch outcome prediction model to each training example of the training dataset to generate a predicted probability of the training attribute resulting in the attrition event from the training picker selecting the training batch for fulfillment;
scoring the batch outcome prediction model using a loss function applied to the predicted probability of the training attribute and the label of the training example; and
updating one or more parameters of the batch outcome prediction model by backpropagation based on the scoring until one or more criteria are satisfied;
selecting one or more attributes of the set based on the determined probabilities; and
generating an interface identifying the selected one or more attributes of the set for transmission to a picker client device of the picker.

12. The computer program product of claim 11, wherein selecting one or more attributes of the set based on the determined probabilities comprises:
ranking the attributes of the set based on the determined probabilities; and
selecting one or more attributes of the set having at least a threshold position in the ranking.

13. The computer program product of claim 12, wherein ranking the attributes of the set based on the determined probabilities comprises ranking attributes of the set with lower determined probabilities to have higher positions in the ranking.

14. The computer program product of claim 11, wherein generating the interface identifying the selected one or more attributes of the set for transmission to a picker client device of the picker comprises:
generating an interface identifying each of a group of attributes of the batch, the interface visually distinguishing the selected one or more attributes of the set from other attributes of the group.

15. The computer program product of claim 11, wherein generating the interface identifying the selected one or more attributes of the set for transmission to a picker client device of the picker comprises:
generating an interface identifying each of a group of attributes of the batch and including an interface element that, when selected by the picker obtains a supplemental interface including the selected one or more attributes of the set from the online system.

16. The computer program product of claim 11, wherein retrieving attributes of the batch comprises retrieving one or more of: a number of unique items in the batch, a total number of units of items included in the batch, a total weight of items included in the batch, a total volume of items included in the batch, a number of items in the batch obtained through specific interactions within a source identified by the batch, a number of items in the batch that are fragile, or any combination thereof.

17. The computer program product of claim 11, wherein retrieving attributes of the batch comprises retrieving one or more of: an estimated amount of time for the picker to fulfill the batch, features of one or more locations for delivering items in the batch, an amount of user interaction by the picker with a user when delivering items in the batch, a total amount of compensation to the picker for fulfilling the batch, an amount the picker receives from one or more users having orders included in the batch for fulfilling the batch, an amount the picker receives for fulfilling the batch, or any combination thereof.

18. The computer program product of claim 11, wherein retrieving characteristics of the picker comprises retrieving a history of prior batches presented to the picker, the history of prior batches including attributes of a prior batch, and an indication whether the picker selected the prior batch.

19. The computer program product of claim 18, wherein the history of prior batches includes one or more attributes of a prior batch that the picker did not select that caused the picker to not select the prior batch.

20. A system comprising:
a processor; and
a non-transitory computer readable storage medium having instructions encoded thereon that, when executed by the processor, cause the processor to perform steps comprising:
obtaining a batch for evaluation by a picker of an online system, the batch including one or more orders;
retrieving attributes of the batch maintained by the online system;
retrieving characteristics of the picker maintained by the online system;
for each of at least a set of attributes of the batch, determining a probability of displaying an attribute of the set of attributes of the batch to the picker resulting in an attrition event from the picker selecting the batch by applying a batch outcome prediction model to the characteristics of the picker, the attribute of the set, and the attributes of the batch, the batch outcome prediction model trained by:
obtaining a training dataset including a plurality of training examples, each training example including a training attribute, training attributes for a training batch, and training characteristics of a training picker, each training example having a label indicating whether the attrition event resulted from the training picker selecting the training batch;
applying the batch outcome prediction model to each training example of the training dataset to generate a predicted probability of the training attribute resulting in the attrition event from the training picker selecting the training batch for fulfillment;
scoring the batch outcome prediction model using a loss function applied to the predicted probability of the training attribute and the label of the training example; and
updating one or more parameters of the batch outcome prediction model by backpropagation based on the scoring until one or more criteria are satisfied;
selecting one or more attributes of the set based on the determined probabilities; and
generating an interface identifying the selected one or more attributes of the set for transmission to a picker client device of the picker.
